(19) United States
(12) Patent Application Publication
(10) Pub. No.: US 2026/0219917 A1
(43) Pub. Date: Jul. 30, 2026

(54) MULTI-PARAMETER BATCH UPSERT STATEMENT EXECUTION

(71) Applicant: SAP SE, Walldorf (DE)

(72) Inventors: Eun Kyung CHI, Seoul (KR); Sukhyeun CHO, Incheon (KR); Min Young SUNG, Seoul (KR); Heeyeon JO, Seoul (KR)

(21) Appl. No.: 19/037,737

(22) Filed: Jan. 27, 2025

(51) Int. Cl. G06F 9/46; G06F 16/2453

(52) U.S. Cl. CPC G06F 9/466; G06F 16/24544

(57) ABSTRACT

A system associated with a cloud computing environment may include an UPSERT batch optimization engine that identifies an UPSERT VALUES (?, ?, ?, …) WITH PRIMARY KEY case. The optimization engine may then receive batch parameters for the UPSERT VALUES (?, ?, ?, …) WITH PRIMARY KEY case and create a temporary table with the received batch parameters. According to some embodiments, the optimization engine can then execute a single left outer join with the temporary table and an UPSERT target table. The optimization engine may then fetch a result of the single left outer join. A Data Manipulation Language (“DML”) execution engine dispatches a set of rows to be inserted and a set of rows to be updated. A partition-wise insert and update run can then be executed in accordance with the set of rows to be inserted and the set of rows to be updated.

### BACKGROUND

A Relational Database Management System (“RDMS”) may use Structured Query Language (“SQL”) statements to INSERT new records or UPDATE/DELETE existing records depending on whether one or more conditions match. Referred to as an “UPSERT” (combining UPDATE and INSERT), such a database statement might take the following form: tablename USING table_reference ON (condition) WHEN MATCHED THEN UPDATE SET column1 = value1 [, column2 = value2 ...] WHEN NOT MATCHED THEN INSERT (column1 [, column2 ...]) VALUES (value1 [, value2 ...]).

FIG. 1 is a system 100 to handle an UPSERT case according to traditional approaches. In particular, the system 100 includes a Data Manipulation Language (“DML”) execution engine 110 that accesses database tables 120. DML is a computer programming language used for adding (inserting), deleting, and modifying (updating) data in a database. A DML is often a sublanguage of a broader database language such as SQL. The DML execution engine 110 might be associated with, for example, a query execution engine that connects the SQL layer with the column store by creating an appropriate SQL plan during a prepare phase. Data in the query engine can be streamed such that early result rows are quickly available without having to wait until all the result rows are processed.

Note that an UPSERT query might be associated with a batch that includes multiple parameters. In this case, the DML execution engine 110 typically performs a one-by-one parameter-wise search execution. This may be because, for example, the system has to check if each parameter value is to be inserted or updated by search, which means the search has to be done row-by-row. That is, when there are N parameters then N separate searches need to be performed. This common approach can be a slow, time-consuming process – especially when there are a substantial number of UPSERT parameters (e.g., an UPSERT could be associated with 7,000 parameters). It would therefore be desirable to provide multi-parameter batch UPSERT statement execution in a secure, automatic, and efficient manner.

### SUMMARY

According to some embodiments, a system associated with a cloud computing environment may include an UPSERT batch optimization engine that identifies an UPSERT VALUES (?, ?, ?, …) WITH PRIMARY KEY case. The optimization engine may then receive batch parameters for the UPSERT VALUES (?, ?, ?, …) WITH PRIMARY KEY case and create a temporary table with the received batch parameters. According to some embodiments, the optimization engine can then execute a single left outer join with the temporary table and an UPSERT target table. The optimization engine may then fetch a result of the single left outer join. A Data Manipulation Language (“DML”) execution engine dispatches a set of rows to be inserted and a set of rows to be updated. A partition-wise insert and update run can then be executed in accordance with the set of rows to be inserted and the set of rows to be updated.

Some embodiments comprise: means for identifying, by a computer processor of an UPSERT batch optimization engine, an UPSERT VALUES (?, ?, ?, …) WITH PRIMARY KEY case; means for receiving batch parameters for the UPSERT VALUES (?, ?, ?, …) WITH PRIMARY KEY case; means for creating a temporary table with the received batch parameters; means for executing a single left outer join with the temporary table and an UPSERT target table; means for fetching a result of the single left outer join; means for dispatching, by a DML execution engine, a set of rows to be inserted and a set of rows to be updated; and means for executing a partition-wise insert and update run in accordance with the set of rows to be inserted and the set of rows to be updated.

Some technical advantages of some embodiments disclosed herein are improved systems and methods to provide multi-parameter batch UPSERT statement execution in a secure, automatic, and efficient manner.

### BRIEF DESCRIPTION OF THE DRAWINGS

FIG. 1 is a system to handle an UPSERT case according to traditional approaches.

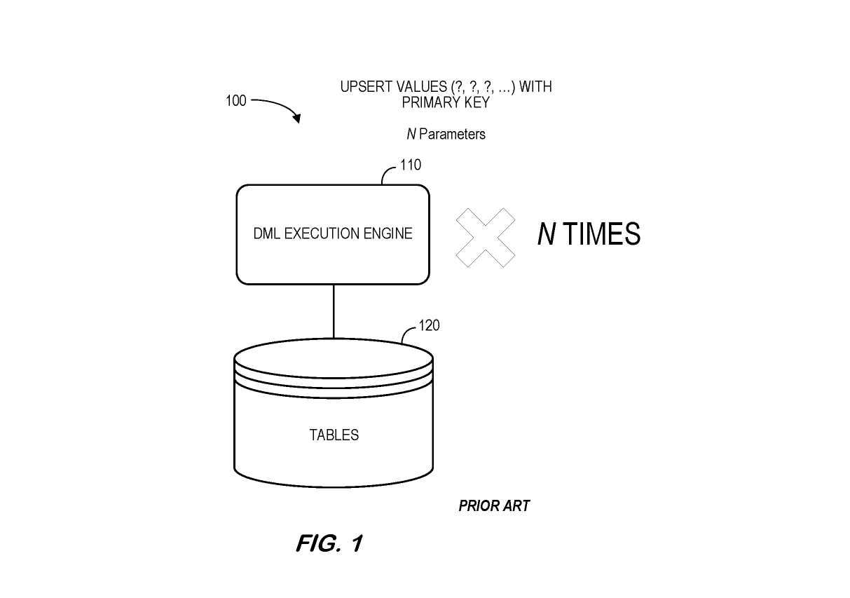

FIG. 2 is a system to handle an UPSERT case in accordance with some embodiments.

FIG. 3 is an UPSERT case method according to some embodiments.

FIG. 4 is an example of a replace with row identifier on join plan initiation in accordance with some embodiments.

FIG. 5 is an example of temporary table creation according to some embodiments.

FIG. 6 is an example of optimization in accordance with some embodiments.

FIG. 7 is an example after a join according to some embodiments.

FIG. 8 is a system providing optimization in accordance with some embodiments.

FIG. 9 is a threshold method according to some embodiments.

FIG. 10 is a condition check method in accordance with some embodiments.

FIG. 11 is an apparatus or platform according to some embodiments.

FIG. 12 is a portion of a table database in accordance with some embodiments.

FIG. 13 illustrates a tablet computer UPSERT batch optimization engine display according to some embodiments.

FIG. 14 is an UPSERT batch optimization engine operator or administrator display in accordance with some embodiments.

### DETAILED DESCRIPTION

In the following detailed description, numerous specific details are set forth in order to provide a thorough understanding of embodiments. However, it will be understood by those of ordinary skill in the art that the embodiments may be practiced without these specific details. In other instances, well-known methods, procedures, components and circuits have not been described in detail so as not to obscure the embodiments.

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers’ specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

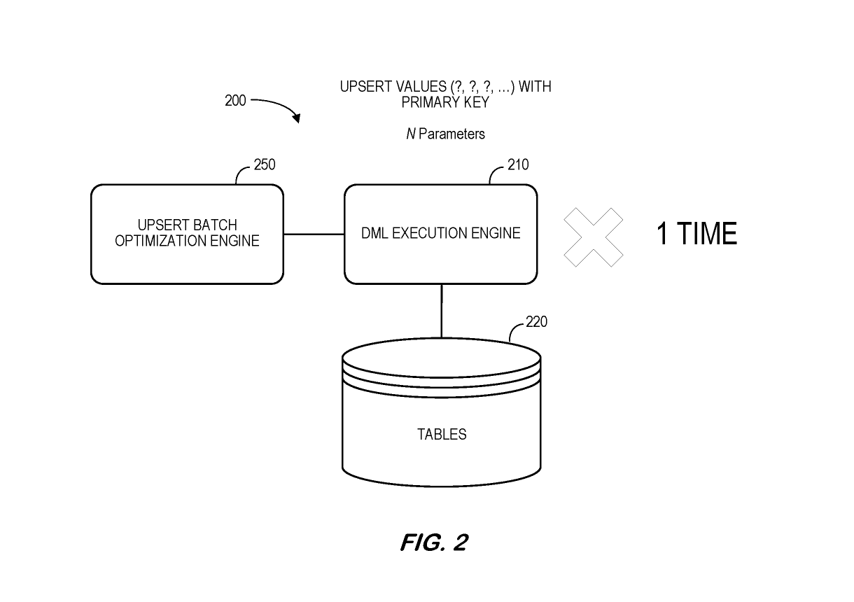

FIG. 2 is a system 200 to handle an UPSERT case in accordance with some embodiments. As before, the system 200 includes a DML execution engine 210 that accesses database tables 220. In this case, however, an UPSERT batch optimization engine 250 coupled to the DML execution engine 210 may help streamline UPSERT commands that have multiple parameters.

As used herein, devices, including those associated with the system 200 and any other device described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The DML execution engine 210 and/or UPSERT batch optimization engine 250 may store information into and/or retrieve information from various data stores (e.g., tables 220), which may be locally stored or reside remote from the DML execution engine 210 and UPSERT batch optimization engine 250. Although a single DML execution engine 210 and UPSERT batch optimization engine 250 are shown in FIG. 2, any number of such devices may be included. Moreover, various devices described herein might be combined according to embodiments of the present invention. For example, in some embodiments, the DML execution engine 210 and UPSERT batch optimization engine 250 might comprise a single apparatus. The system 200 functions may be performed by a constellation of networked apparatuses, such as in a distributed processing or cloud-based architecture. In some cases, the DML execution engine 210 and/or UPSERT batch optimization engine 250 can process information associated with a number of different tenants or customers of an enterprise.

An enterprise may access the system 200 via a remote device (e.g., a Personal Computer (“PC”), tablet, or smartphone) to view information about and/or manage operational information in accordance with any of the embodiments described herein. In some cases, an interactive Graphical User Interface (“GUI”) display may let an operator or administrator define and/or adjust certain parameters via a remote device (e.g., to specify a threshold boundary for a computing environment infrastructure) and/or provide or receive automatically generated recommendations, alerts, summaries, or results associated with the system 200.

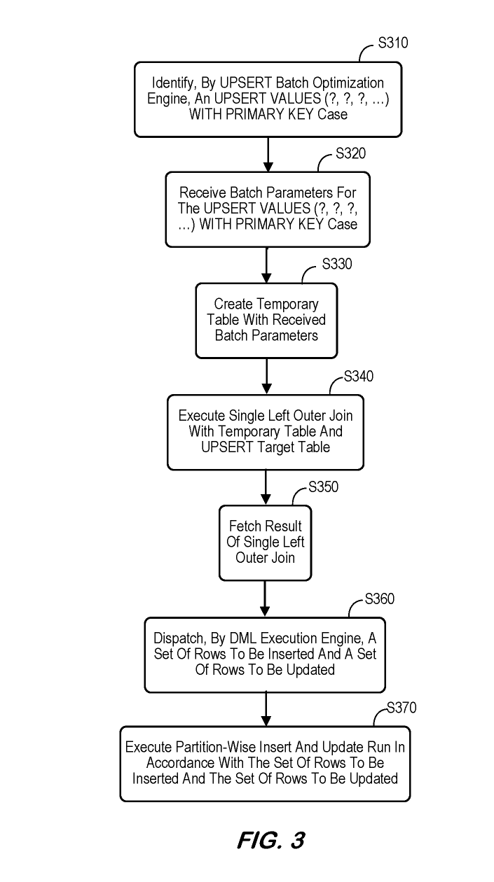

FIG. 3 is a method that might be performed by the system 200 described with respect to FIG. 2 according to some embodiments. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S310, a computer processor of an UPSERT batch optimization engine may identify an UPSERT VALUES (?, ?, ?, …) WITH PRIMARY KEY case. At S320, the UPSERT batch optimization engine may receive batch parameters for the UPSERT VALUES (?, ?, ?, …) WITH PRIMARY KEY case. The UPSERT batch optimization engine can then create a temporary table with the received batch parameters at S330. According to some embodiments, the UPSERT batch optimization engine also creates an UPSERT target table for the use case.

At S340, a single left outer join is executed with the temporary table and the UPSERT target table. As used herein, the phrase “outer join” many refer to a query that returns both: (1) the records of the cross-product for which there is an entry in all tables used in the view, and (2) records for which there is no entry in some of the tables used in the view. A result of the single left outer join is then fetched at S350. At S360, a DML execution engine dispatches a set of rows to be inserted and a set of rows to be updated. The set of rows to be inserted may, for example, comprise rows in the result of the single left outer join that have a NULL row identifier. At S370, a partition-wise insert and update run is executed in accordance with the set of rows to be inserted and the set of rows to be updated. according to some embodiments, the insert update run utilizes a partition-wise split internal table. In this way, the UPSERT batch optimization engine can reduce search and storage requirements of the DML execution engine.

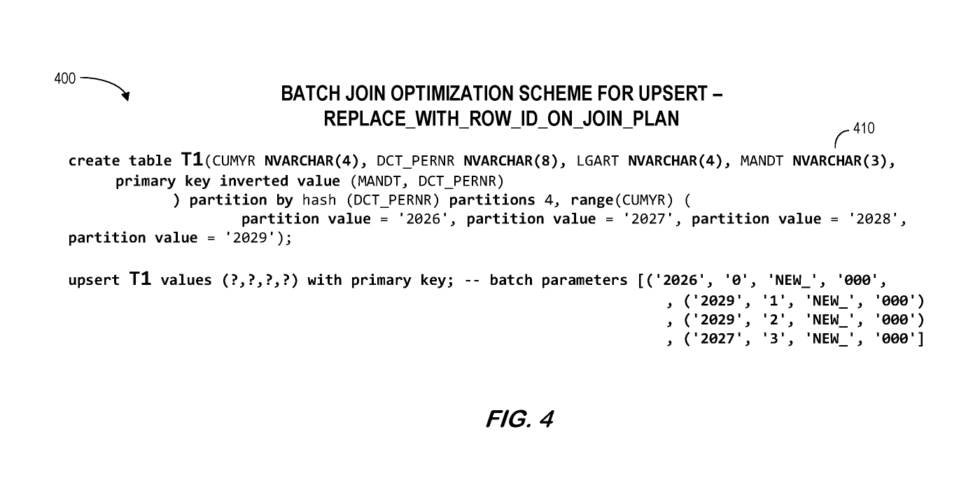

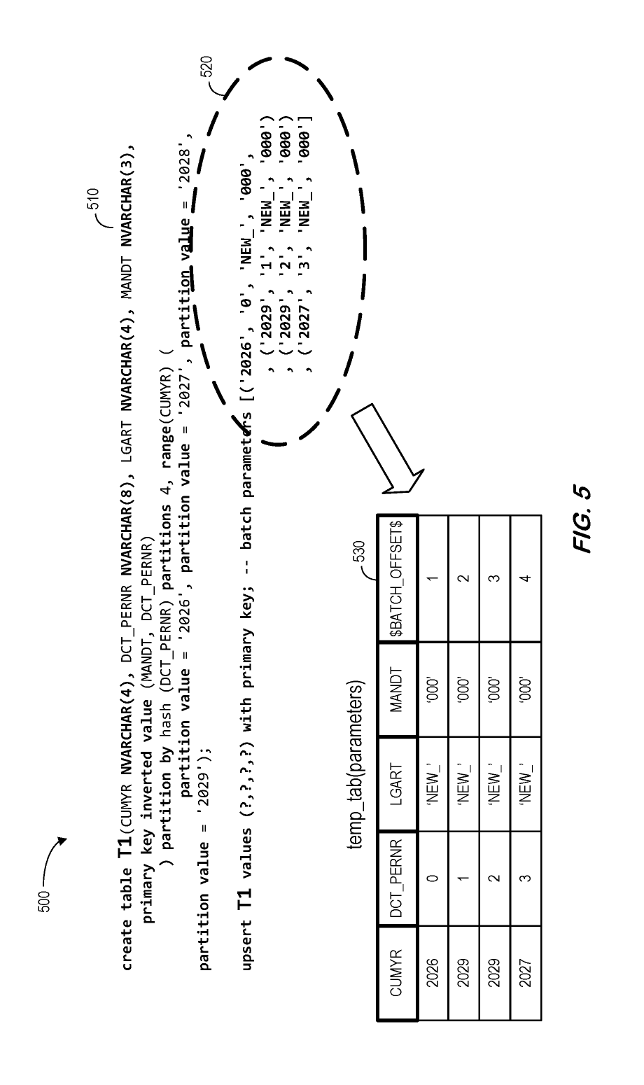

FIG. 4 is an example 400 of a replace with row identifier on join plan initiation in accordance with some embodiments. In particular, an UPSERT target table “T1” is created 410 including the following columns: CUMYR, DCT_PERNR, LGART, and MANDT. Moreover, a four-parameter batch UPSERT of T1 values is requested 420. FIG. 5 is an example 500 of temporary table 530 creation (named “temp_tab(parameters)”) in response to the four-parameter 520 batch UPSERT according to some embodiments. The table 530 includes four rows, each including the following columns: CUMYR, DCT_PERNR, LGART, MANDT, and a temporary $BATCH_OFFSET$ column that is added by the system to ensure uniqueness.

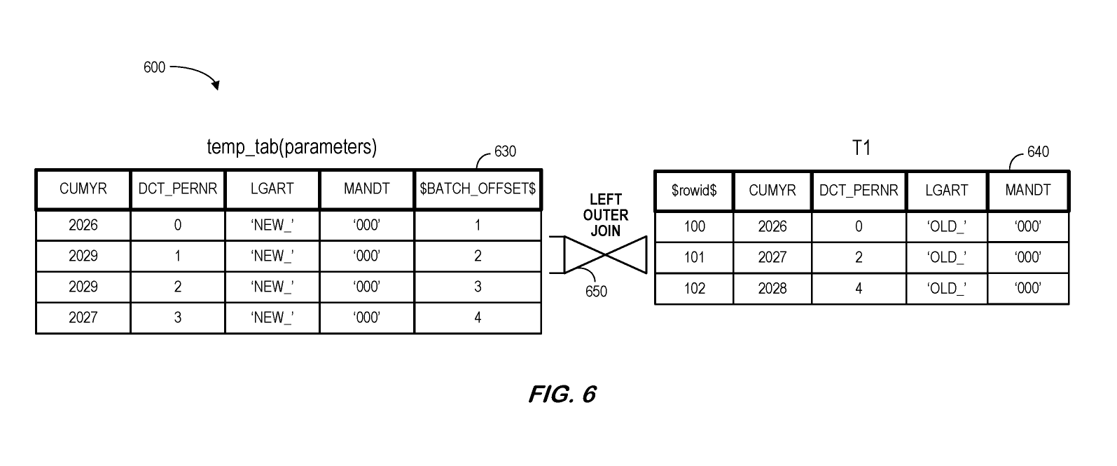

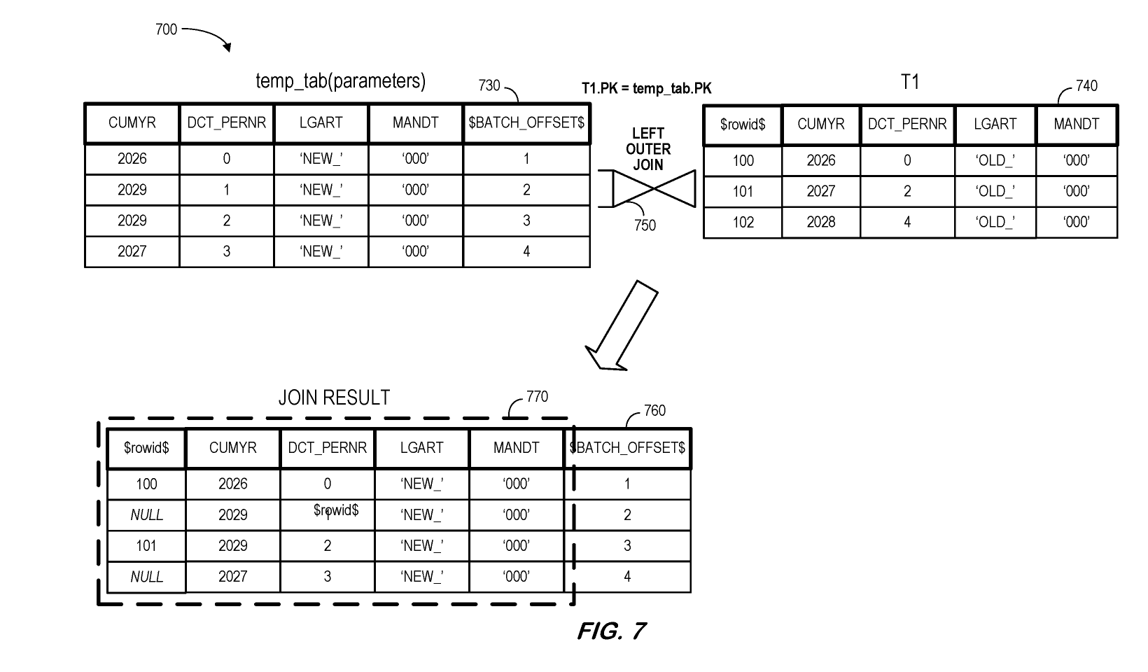

FIG. 6 is an example 600 of optimization in accordance with some embodiments. Here, a left outer join 650 is performed on the temporary table 630 (“temp_tab(parameters)”) and an UPSERT target table (“T1”) 640 that includes the following columns: $rowid$, CUMYR, DCT_PERNR, LGART, and MANDT. The left outer join 650 might comprise, for example “T1PK = temp_tab.PK.” FIG. 7 is an example 700 after a join according to some embodiments. Here, the left outer join 750 has been performed on the temporary table 730 (“temp_tab(parameters)”) and the UPSERT target table (“T1”) 740 which creates an output table 760 that includes a join result 770. According to some embodiments, rows in the temporary table 730 that were not present in the UPSERT target table 740 are given a $rowid$ of “NULL.”

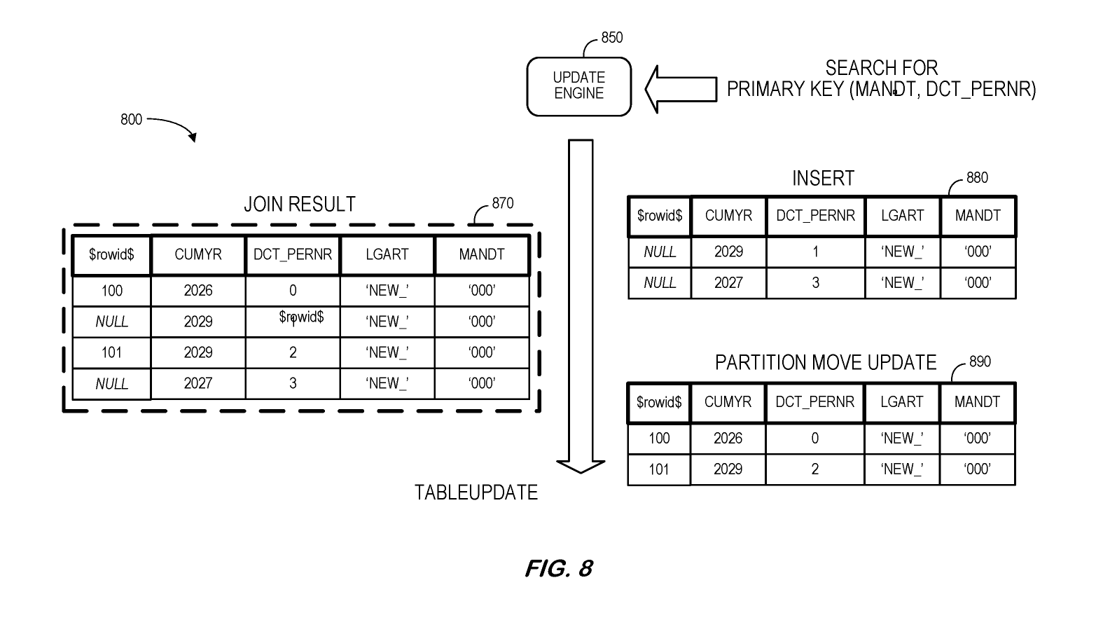

FIG. 8 is a system 800 providing optimization in accordance with some embodiments. The join result 870 can be used by an update engine 850 to perform a single partition-wise insert and update run. In particular, join result 870 rows with a $rowid$ of “NULL” will need to be inserted 880 into the target table. Similarly, join result 870 rows with a $rowid$ that is not “NULL” already exist and can simply be updated in the target table with a partition and move update 890.

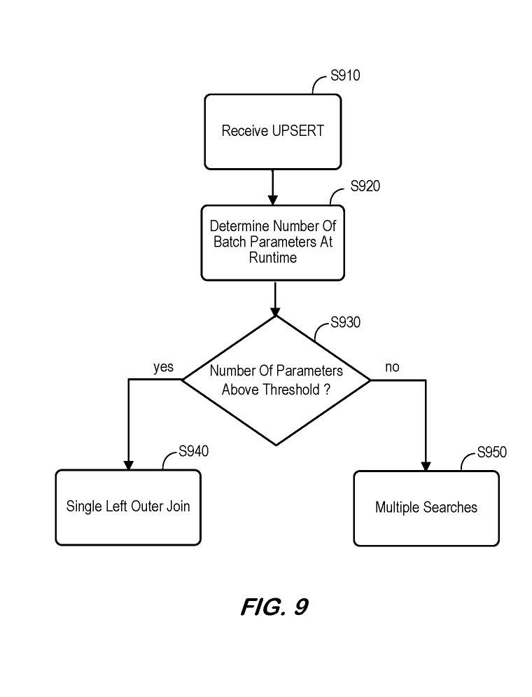

In some embodiments, whether it would be better to perform a single left outer join or a one-by-one parameter-wise search execution can be determined at runtime and/or be a configurable parameter. For example, FIG. 9 is a threshold method according to some embodiments. In this case, an UPSERT batch optimization engine may identify an UPSERT VALUES (?, ?, ?, …) WITH PRIMARY KEY case at S910. At S920, the system may determine a number of batch parameters at runtime. For example, does this UPSERT involve 100 parameters, 1,000 parameters, etc.? At S930, it is determined if the number of batch parameters associated with the UPSERT is more than a threshold number. For example, the system might use a default threshold number or read a user-selected threshold number from a configuration file. If the number of batch parameters associated with the UPSERT is more than a threshold number at S930, then a single left outer join is performed (as described with respect to FIGS. 4 through 8) at S940. If the number of batch parameters associated with the UPSERT is not more than a threshold number at S930, then a traditional one-by-one parameter-wise search execution is performed at S950.

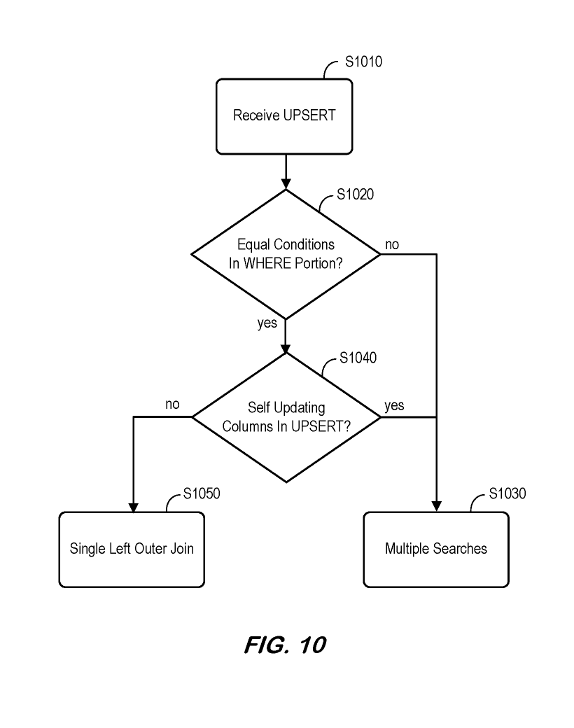

Note that the single left outer join approach might not be appropriate for all UPSERT cases (e.g., it might not be appropriate for subquery predicates, self-update columns, etc.). For example, FIG. 10 is a condition check method in accordance with some embodiments. In this case, an UPSERT batch optimization engine may identify an UPSERT VALUES (?, ?, ?, …) WITH PRIMARY KEY case at S1010. If there are not primary key equal conditions as a WHERE portion of the UPSERT VALUES (?, ?, ?, …) WITH PRIMARY KEY case at S1020, then a traditional one-by-one parameter-wise search execution is performed at S1030. If there are primary key equal conditions as a WHERE portion of the UPSERT VALUES (?, ?, ?, …) WITH PRIMARY KEY case at S1020 then, another condition might be checked. For example, if there are self-updating columns in the UPSERT VALUES (?, ?, ?, …) WITH PRIMARY KEY case at S1040, then a traditional one-by-one parameter-wise search execution is performed at S1030. if there are self-updating columns in the UPSERT VALUES (?, ?, ?, …) WITH PRIMARY KEY case at S1040, then a single left outer join is performed (as described with respect to FIGS. 4 through 8) at S1050. That is, the single left outer join might only be performed when both: (1) there are primary key equal conditions as a WHERE portion of the UPSERT VALUES (?, ?, ?, …) WITH PRIMARY KEY case and (2) there are no self-updating columns in the UPSERT VALUES (?, ?, ?, …) WITH PRIMARY KEY case.

Embodiments described here may substantially improve performance. Consider, for example a benchmark with an UPSERT having 2,000 batch parameters that performs a partition move and utilizes a first level hash partition and a second level range partition. This benchmark is provided only as an example and embodiments might use any number of other approaches. With such a benchmark, the traditional row-by-row search might result in an elapsed time of 80,000 milliseconds (ms) while the single left outer join results in an elapsed time of 4,800 ms (an improvement factor of approximately 17x). Similarly, the traditional row-by-row search might result in a CPU service time of 87,000 ms while the single left outer join results in a CPU service time of 18,500 ms (an improvement factor of approximately 5x). In addition, the traditional row-by-row search might result in a memory heap integral of 8,00 MB while the single left outer join results in a memory heap integral of 334 MB (an improvement factor of 25x). Moreover, even better performance impacts may be expected with increasing numbers of UPSERT batch parameters.

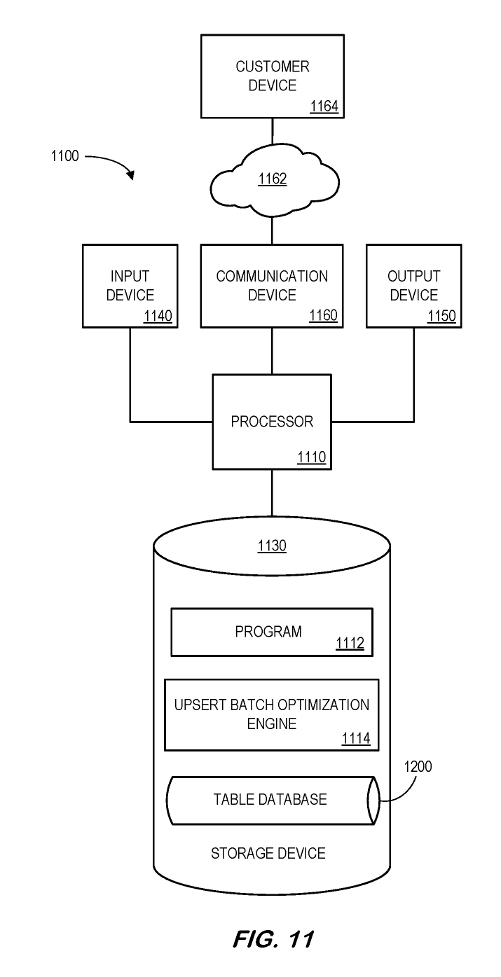

Note that the embodiments described herein may be implemented using any number of different hardware configurations. For example, FIG. 11 is a block diagram of an apparatus or platform 1100 that may be, for example, associated with the system 200 of FIG. 2 (and/or any other system described herein). The platform 1100 comprises a processor 1110, such as one or more commercially available Central Processing Units (“CPUs”) in the form of one-chip microprocessors, coupled to a communication device 1160 configured to communicate via a communication network 1162 (e.g., a distributed computer network). The communication device 1160 may be used to communicate, for example, with one or more remote tenant or customer devices 1164 via the communication network 1162. The platform 1100 further includes an input device 1140 (e.g., a computer mouse and/or keyboard to input data mappings, cloud configurations, etc.) and an output device 1150 (e.g., a computer monitor to render a display, transmit recommendations, charts, alerts, and/or reports about a UPSERT performance and optimizations, etc.).

The processor 1110 is also communicates with a storage device 1130. The storage device 1130 may comprise any appropriate information storage device, including combinations of magnetic storage devices (e.g., a hard disk drive), optical storage devices, mobile telephones, and/or semiconductor memory devices. The storage device 1130 stores a program 1112 and/or an UPSERT batch optimization engine 1114 for controlling the processor 1110. The processor 1110 performs instructions of the programs 1112, 1114, and thereby operates in accordance with any of the embodiments described herein. For example, the processor 1110 may identify an UPSERT VALUES (?, ?, ?, …) WITH PRIMARY KEY case. The processor 1110 may then receive batch parameters for the UPSERT VALUES (?, ?, ?, …) WITH PRIMARY KEY case and create a temporary table with the received batch parameters. According to some embodiments, the processor 1110 can then execute a single left outer join with the temporary table and an UPSERT target table. The processor 1110 may then fetch a result of the single left outer join. A DML execution engine can dispatch a set of rows to be inserted and a set of rows to be updated. A partition-wise insert and update run is then executed in accordance with the set of rows to be inserted and the set of rows to be updated.

The programs 1112, 1114 may be stored in a compressed, uncompiled and/or encrypted format. The programs 1112, 1114 may furthermore include other program elements, such as an operating system, clipboard application, a database management system, and/or device drivers used by the processor 1110 to interface with peripheral devices.

As used herein, information may be “received” by or “transmitted” to, for example: (i) the platform 1100 from another device; or (ii) a software application or module within the platform 1100 from another software application, module, or any other source.

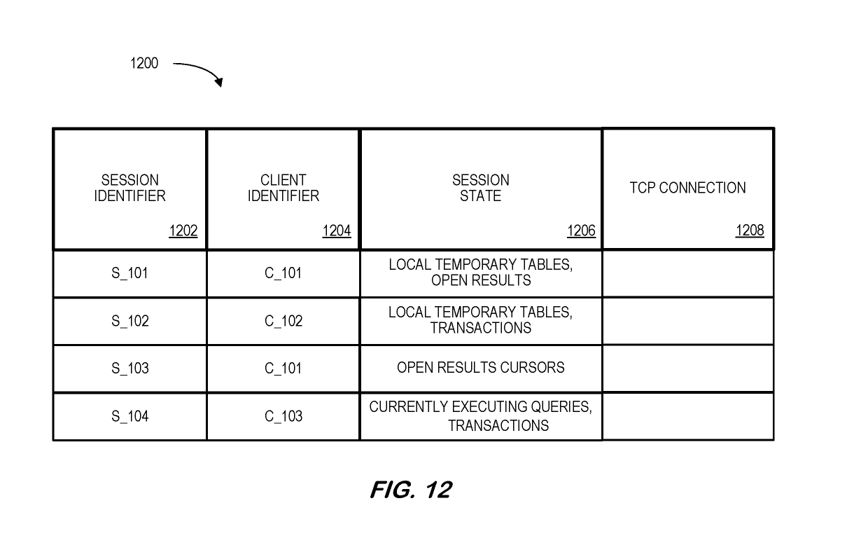

In some embodiments (such as the one shown in FIG. 11), the storage device 1130 further stores a table database 1200. An example of a database that may be used in connection with the platform 1100 will now be described in detail with respect to FIG. 12. Note that the database described herein is only one example, and additional and/or different information may be stored therein. Moreover, various databases might be split or combined in accordance with any of the embodiments described herein.

Referring to FIG. 12, a table is shown that represents the table database 1200 that may be stored at the platform 1100 according to some embodiments. The table may include, for example, entries identifying UPSERT statements that have been processed via an optimization engine. The table may also define fields 1202, 1204, 1206, 1208 for each of the entries. The fields 1202, 1204, 1206, 1208 may, according to some embodiments, specify: an UPSERT case identifier 1202, a temporary table identifier 1204, an upsert target table identifier 1206, and a result table identifier 1208. The table database 1200 may be created and updated, for example, when a new UPSERT is identified, parameters have been determined, a left outer join is performed, etc.

The UPSERT case identifier 1202 might be a unique alphanumeric label or link that is associated with an UPSERT statement that has been identified. The temporary table identifier 1204 might contain the batch parameters associated that that UPSERT statement. The upsert target table identifier 1206 may comprise the existing table that will be updated. The result table identifier 1208 might be generated by a left inner join of the temporary table and the UPSERT target table. The result table can then be used to determine information that can be inserted and information that can be updated.

Thus, embodiments may provide an efficient batch optimization for UPSERT, especially when a substantial number of parameters are included in a batch. The previous execution plan was to run each parameter one-by-one, but this is parameter-wise bulk handling so a single join search can retrieve all expected search results at once. Reducing communication of search/storage will lead to performance benefits.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with some embodiments of the present invention (e.g., some of the information associated with the databases described herein may be combined or stored in external systems). Moreover, although some embodiments are focused on particular types of database tables, any of the embodiments described herein could be applied to other types of tables.

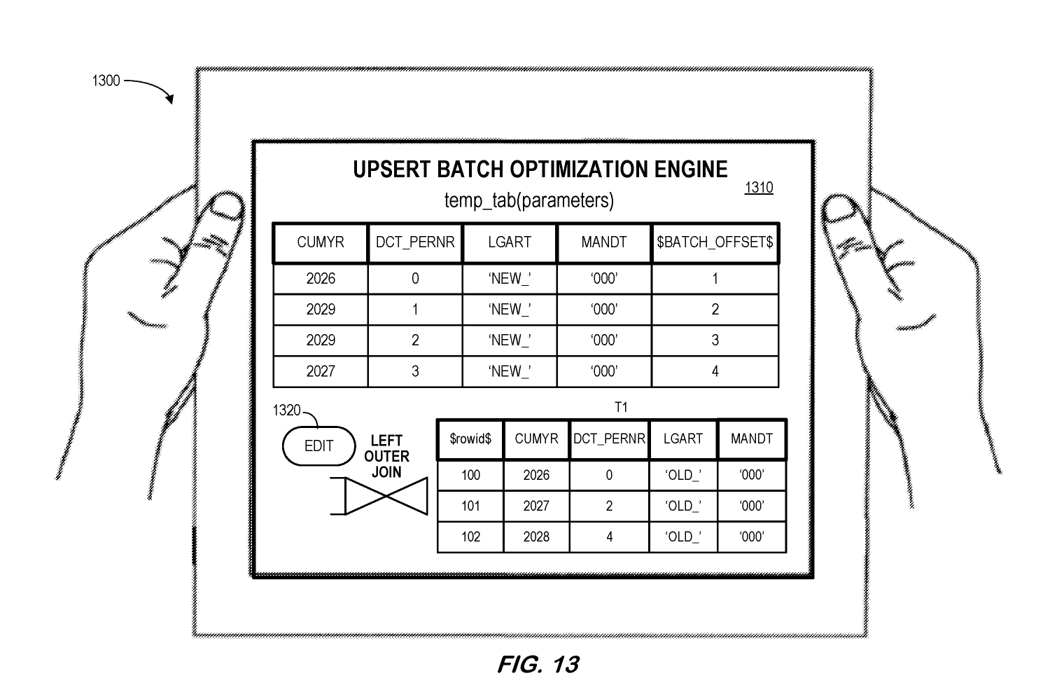

In addition, the displays shown herein are provided only as examples, and any other type of user interface could be implemented. For example, FIG. 13 illustrates a tablet computer 1300 providing an UPSERT batch optimization engine display 1310 according to some embodiments. The UPSERT batch optimization engine display 1310 might be used, for example, to troubleshoot system performance, review information mappings and results, etc. A user may interact with the display 1310, such as by touching an element of the display 1310 and selecting an “Edit” icon 1320. In this way, the user may see more information change settings for an element of the configuration system or framework.

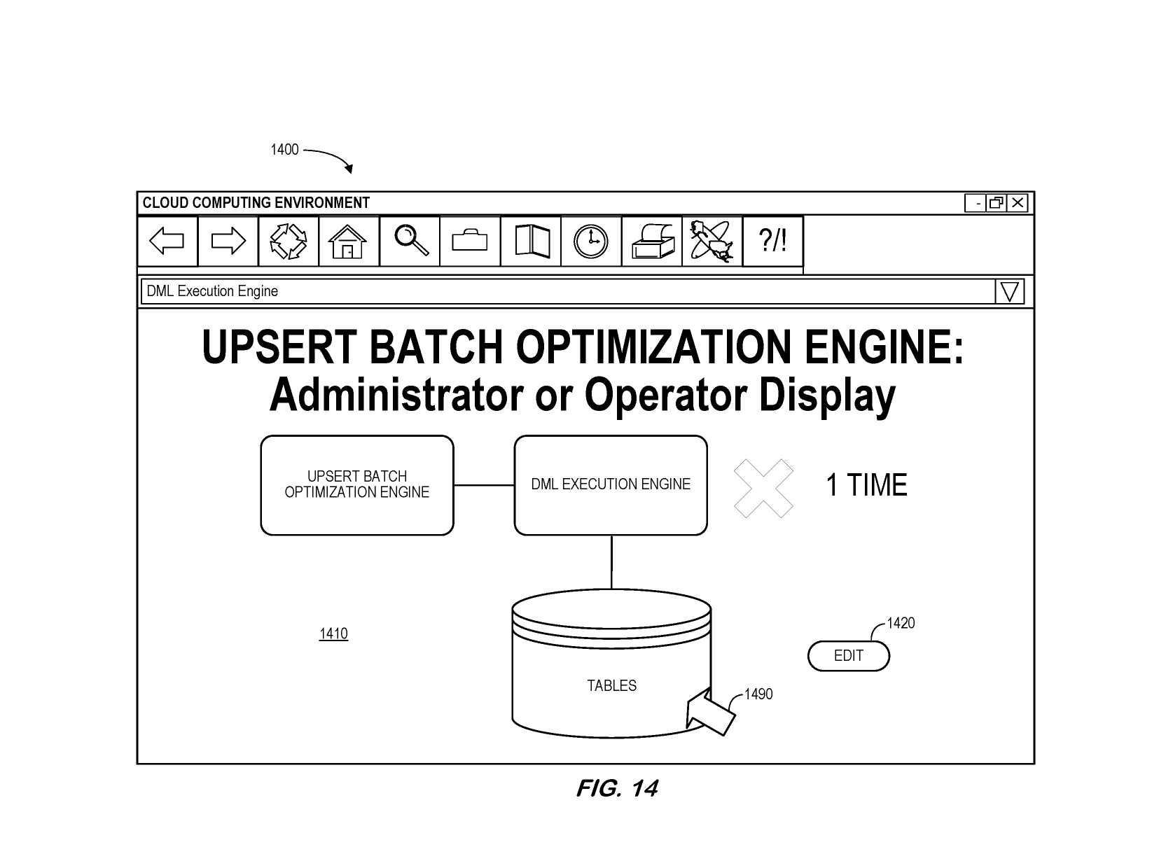

FIG. 14 is an operator or administrator display 1400 in accordance with some embodiments. The display 1400 includes a graphical representation 1410 of an UPSERT batch optimization engine in accordance with any of the embodiments described herein. Selection of an element on the display 1400 (e.g., via a touchscreen or computer pointer 1490) may result in display of a pop-up window containing more detailed information about that element and/or various options (e.g., to define how information is mapped, adjust threshold values, rules, and logic, etc.). Selection of an “Edit” icon 1420 may also let an operator or administrator alter the operation of the system (e.g., to change a mapping to a data store, adjust cloud environment properties, etc.).

The present invention has been described in terms of several embodiments solely for the purpose of illustration. Persons skilled in the art will recognize from this description that the invention is not limited to the embodiments described but may be practiced with modifications and alterations limited only by the spirit and scope of the appended claims.

1. A system associated with a cloud computing environment, comprising:
an UPSERT batch optimization engine, including:
a computer processor, and
a computer memory storing instructions that, when executed by the computer processor, cause the UPSERT batch optimization engine to:
identify an UPSERT VALUES (?, ?, ?, …) WITH PRIMARY KEY case,
receive batch parameters for the UPSERT VALUES (?, ?, ?, …) WITH PRIMARY KEY case,
create a temporary table with the received batch parameters,
execute a single left outer join with the temporary table and an UPSERT target table,
fetch a result of the single left outer join,
dispatch, by a Data Manipulation Language (“DML”) execution engine, a set of rows to be inserted and a set of rows to be updated, and
execute a partition-wise insert and update run in accordance with the set of rows to be inserted and the set of rows to be updated.

2. The system of claim 1, wherein the insert update run utilizes a partition-wise split internal table.

3. The system of claim 1, wherein the single left outer join is executed only if there is more than a threshold number of batch parameters at runtime.

4. The system of claim 3, wherein a one-by-one parameter-wise search execution is performed if there is not more than a threshold number of batch parameters at runtime.

5. The system of claim 1, wherein the single left outer join is executed only when there are the single left outer join is executed only when there are primary key equal conditions as a WHERE portion of the UPSERT VALUES (?, ?, ?, …) WITH PRIMARY KEY case.

6. The system of claim 1, wherein the single left outer join is executed only when there are no self-updating columns in the UPSERT VALUES (?, ?, ?, …) WITH PRIMARY KEY case.

7. The system of claim 1, wherein the UPSERT batch optimization engine reduces search and storage requirements of the DML execution engine.

8. The system of claim 1, wherein the UPSERT batch optimization engine is further to create the UPSERT target table.

9. The system of claim 1, wherein the set of rows to be inserted comprises rows in the result of the single left outer join with a NULL row identifier.

10. A computer-implemented method associated with a cloud computing database infrastructure, comprising:
identifying, by a computer processor of an UPSERT batch optimization engine, an UPSERT VALUES (?, ?, ?, …) WITH PRIMARY KEY case;
receiving batch parameters for the UPSERT VALUES (?, ?, ?, …) WITH PRIMARY KEY case;
creating a temporary table with the received batch parameters;
executing a single left outer join with the temporary table and an UPSERT target table;
fetching a result of the single left outer join;
dispatching, by a Data Manipulation Language (“DML”) execution engine, a set of rows to be inserted and a set of rows to be updated; and
executing a partition-wise insert and update run in accordance with the set of rows to be inserted and the set of rows to be updated.

11. The method of claim 10, wherein the insert update run utilizes a partition-wise split internal table.

12. The method of claim 10, wherein the single left outer join is executed only if there is more than a threshold number of batch parameters at runtime.

13. The method of claim 10, wherein a one-by-one parameter-wise search execution is performed if there is not more than a threshold number of batch parameters at runtime.

14. The method of claim 10, wherein the single left outer join is executed only when there are the single left outer join is executed only when there are primary key equal conditions as a WHERE portion of the UPSERT VALUES (?, ?, ?, …) WITH PRIMARY KEY case.

15. The method of claim 10, wherein the single left outer join is executed only when there are no self-updating columns in the UPSERT VALUES (?, ?, ?, …) WITH PRIMARY KEY case.

16. One or more non-transitory computer-readable media storing computer-executable instructions that, when executed by a computing system, cause the computing system to perform operations comprising:
identifying, by a computer processor of an UPSERT batch optimization engine, an UPSERT VALUES (?, ?, ?, …) WITH PRIMARY KEY case;
receiving batch parameters for the UPSERT VALUES (?, ?, ?, …) WITH PRIMARY KEY case;
creating a temporary table with the received batch parameters;
executing a single left outer join with the temporary table and an UPSERT target table;
fetching a result of the single left outer join;
dispatching, by a Data Manipulation Language (“DML”) execution engine, a set of rows to be inserted and a set of rows to be updated; and
executing a partition-wise insert and update run in accordance with the set of rows to be inserted and the set of rows to be updated.

17. The media of claim 16, wherein a one-by-one parameter-wise search execution is performed if there is not more than a threshold number of batch parameters at runtime.

18. The media of claim 16, wherein the UPSERT batch optimization engine reduces search and storage requirements of the DML execution engine.

19. The media of claim 16, wherein the UPSERT batch optimization engine is further to create the UPSERT target table.

20. The media of claim 18, wherein the set of rows to be inserted comprises rows in the result of the single left outer join with a NULL row identifier.
